(19) United States
(12) Patent Application Publication
(10) Pub. No.: US 2024/0223318 A1
(43) Pub. Date: Jul. 4, 2024

(54) TRANSMISSION CONFIGURATION INDICATOR (TCI) INDICATION IN DOWNLINK CONTROL INFORMATION SCHEDULING A VIRTUAL PHYSICAL DOWNLINK SHARED CHANNEL

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Jing SUN, San Diego, CA (US); Tao LUO, San Diego, CA (US)

(21) Appl. No.: 18/573,021

(22) PCT Filed: Aug. 6, 2021
(86) PCT No.: PCT/CN2021/111122

§ 371 Date: Dec. 21, 2023

(51) Int. Cl. H04L 1/1829; H04W 72/0446; H04W 72/232

(52) U.S. Cl. CPC H04L 1/1864; H04W 72/0446; H04W 72/232

(57) ABSTRACT

Various aspects of the present disclosure generally relate to wireless communication. In some aspects, a user equipment (UE) may receive a physical downlink shared channel communication in a first resource, wherein the first resource is associated with a beam indication downlink control information with a time domain resource allocation field identifying a parameter relating to the physical downlink shared channel communication. The UE may transmit, in a physical uplink control channel, hybrid automatic repeat request feedback information in a second resource, wherein the second resource is based at least in part on the first resource and a configuration of the parameter relating to the physical downlink shared channel communication. Numerous other aspects are described.

### FIELD OF THE DISCLOSURE

Aspects of the present disclosure generally relate to wireless communication and to techniques and apparatuses for transmission configuration indicator (TCI) indication in downlink control information scheduling a virtual physical downlink shared channel (PDSCH).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive a physical downlink shared channel communication in a first resource, wherein the first resource is associated with a beam indication downlink control information with a time domain resource allocation field identifying a parameter relating to the physical downlink shared channel communication. The one or more processors may be configured to transmit, in a physical uplink control channel, hybrid automatic repeat request feedback information in a second resource, wherein the second resource is based at least in part on the first resource and a configuration of the parameter relating to the physical downlink shared channel communication.

Some aspects described herein relate to a base station for wireless communication. The base station may include a memory and one or more processors coupled to the memory. The one or more processors may be configured to transmit a physical downlink shared channel communication in a first resource, wherein the first resource is associated with a beam indication downlink control information with a time domain resource allocation field identifying a parameter relating to the physical downlink shared channel communication. The one or more processors may be configured to receive, in a physical uplink control channel, hybrid automatic repeat request feedback information in a second resource, wherein the second resource is based at least in part on the first resource and a configuration of the parameter relating to the physical downlink shared channel communication.

Some aspects described herein relate to a method of wireless communication performed by a UE. The method may include receiving a physical downlink shared channel communication in a first resource, wherein the first resource is associated with a beam indication downlink control information with a time domain resource allocation field identifying a parameter relating to the physical downlink shared channel communication. The method may include transmitting, in a physical uplink control channel, hybrid automatic repeat request feedback information in a second resource, wherein the second resource is based at least in part on the first resource and a configuration of the parameter relating to the physical downlink shared channel communication.

Some aspects described herein relate to a method of wireless communication performed by a base station. The method may include transmitting a physical downlink shared channel communication in a first resource, wherein the first resource is associated with a beam indication downlink control information with a time domain resource allocation field identifying a parameter relating to the physical downlink shared channel communication. The method may include receiving, in a physical uplink control channel, hybrid automatic repeat request feedback information in a second resource, wherein the second resource is based at least in part on the first resource and a configuration of the parameter relating to the physical downlink shared channel communication.

Some aspects described herein relate to a non-transitory computer-readable medium that stores a set of instructions for wireless communication by a UE. The set of instructions, when executed by one or more processors of the UE, may cause the UE to receive a physical downlink shared channel communication in a first resource, wherein the first resource is associated with a beam indication downlink control information with a time domain resource allocation field identifying a parameter relating to the physical downlink shared channel communication. The set of instructions, when executed by one or more processors of the UE, may cause the UE to transmit, in a physical uplink control channel, hybrid automatic repeat request feedback information in a second resource, wherein the second resource is based at least in part on the first resource and a configuration of the parameter relating to the physical downlink shared channel communication.

Some aspects described herein relate to a non-transitory computer-readable medium that stores a set of instructions for wireless communication by a base station. The set of instructions, when executed by one or more processors of the base station, may cause the base station to transmit a physical downlink shared channel communication in a first resource, wherein the first resource is associated with a beam indication downlink control information with a time domain resource allocation field identifying a parameter relating to the physical downlink shared channel communication. The set of instructions, when executed by one or more processors of the base station, may cause the base station to receive, in a physical uplink control channel, hybrid automatic repeat request feedback information in a second resource, wherein the second resource is based at least in part on the first resource and a configuration of the parameter relating to the physical downlink shared channel communication.

Some aspects described herein relate to an apparatus for wireless communication. The apparatus may include means for receiving a physical downlink shared channel communication in a first resource, wherein the first resource is associated with a beam indication downlink control information with a time domain resource allocation field identifying a parameter relating to the physical downlink shared channel communication. The apparatus may include means for transmitting, in a physical uplink control channel, hybrid automatic repeat request feedback information in a second resource, wherein the second resource is based at least in part on the first resource and a configuration of the parameter relating to the physical downlink shared channel communication.

Some aspects described herein relate to an apparatus for wireless communication. The apparatus may include means for transmitting a physical downlink shared channel communication in a first resource, wherein the first resource is associated with a beam indication downlink control information with a time domain resource allocation field identifying a parameter relating to the physical downlink shared channel communication. The apparatus may include means for receiving, in a physical uplink control channel, hybrid automatic repeat request feedback information in a second resource, wherein the second resource is based at least in part on the first resource and a configuration of the parameter relating to the physical downlink shared channel communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of physical channels and reference signals in a wireless network, in accordance with the present disclosure.

FIG. 4 is a diagram illustrating an example of using beams for communications between a base station and a UE, in accordance with the present disclosure.

FIGS. 5A and 5B are diagrams illustrating examples associated with transmission configuration indicator (TCI) indication in downlink control information (DCI) scheduling a virtual physical downlink shared channel (PDSCH), in accordance with the present disclosure.

FIGS. 6-7 are diagrams illustrating example processes associated with TCI indication in DCI scheduling a PDSCH, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

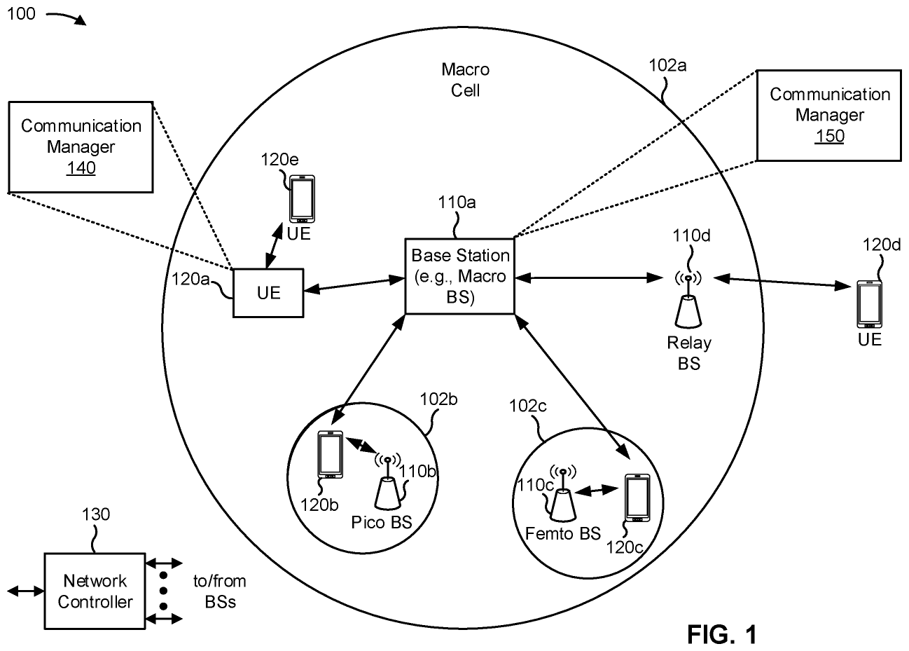

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrow band IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHZ. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHZ). FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a physical downlink shared channel communication in a first resource, wherein the first resource is associated with a beam indication downlink control information with a time domain resource allocation field identifying a parameter relating to the physical downlink shared channel communication: and transmit, in a physical uplink control channel, hybrid automatic repeat request feedback information in a second resource, wherein the second resource is based at least in part on the first resource and a configuration of the parameter relating to the physical downlink shared channel communication. Additionally, or alternatively, the communication manager 140 may perform one or more other operations described herein.

In some aspects, the base station 110 may include a communication manager 150. As described in more detail elsewhere herein, the communication manager 150 may transmit a physical downlink shared channel communication in a first resource, wherein the first resource is associated with a beam indication downlink control information with a time domain resource allocation field identifying a parameter relating to the physical downlink shared channel communication: and receive, in a physical uplink control channel, hybrid automatic repeat request feedback information in a second resource, wherein the second resource is based at least in part on the first resource and a configuration of the parameter relating to the physical downlink shared channel communication. Additionally, or alternatively, the communication manager 150 may perform one or more other operations described herein.

As indicated above. FIG. 1 is provided as an example. Other examples may differ from what is described with regard to FIG. 1.

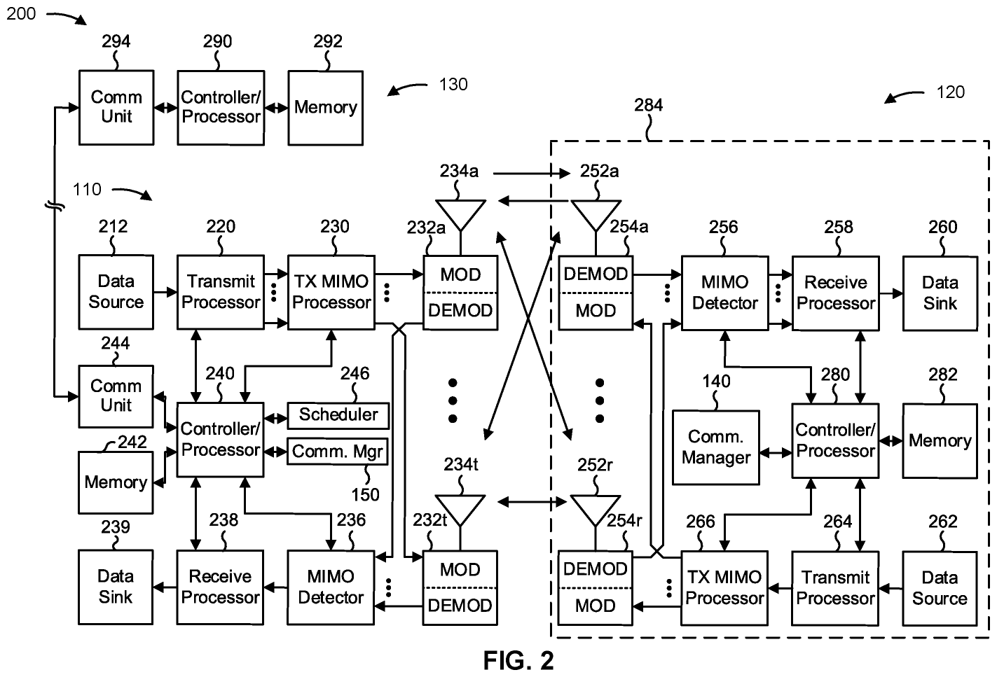

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

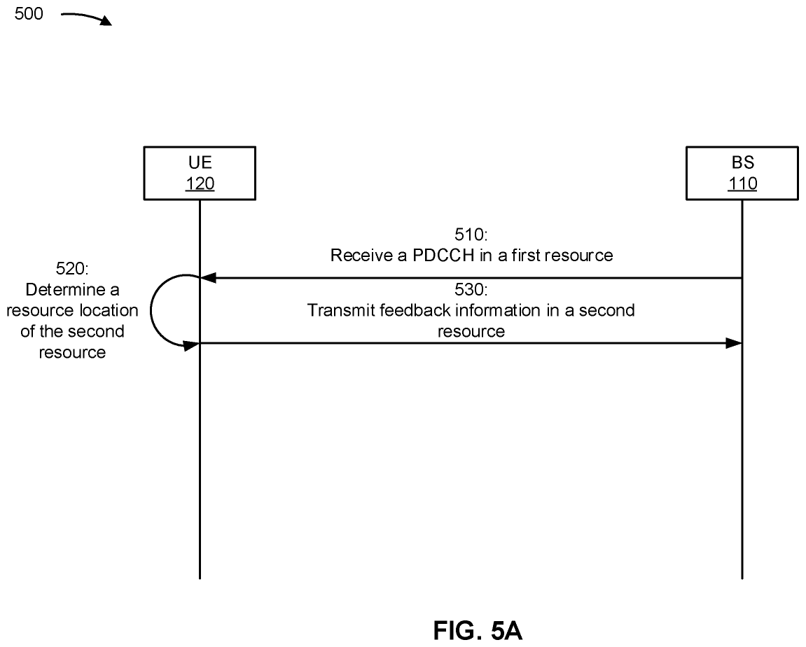

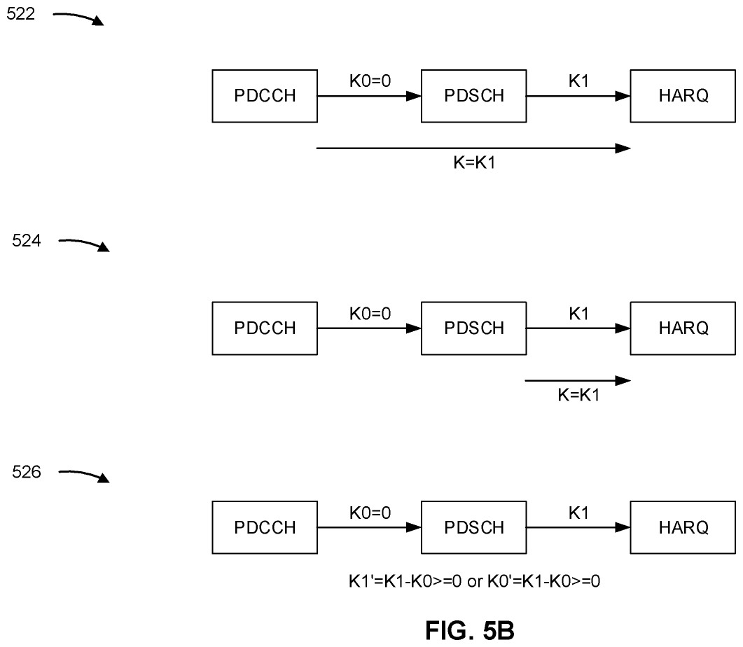

On the uplink, at the UE 120, a transmit processor 264 may receive and process data from a data source 262 and control information (e.g., for reports that include RSRP. RSSI. RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

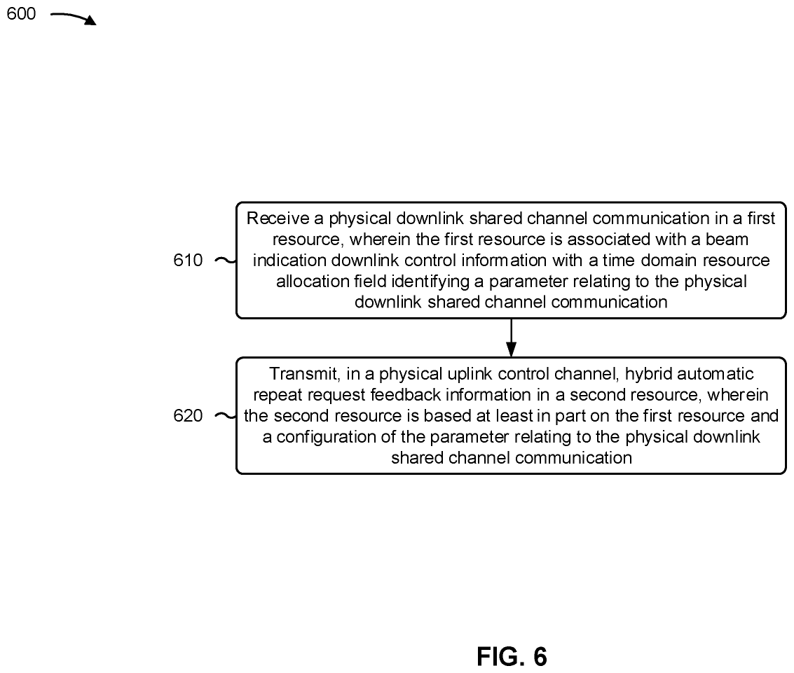

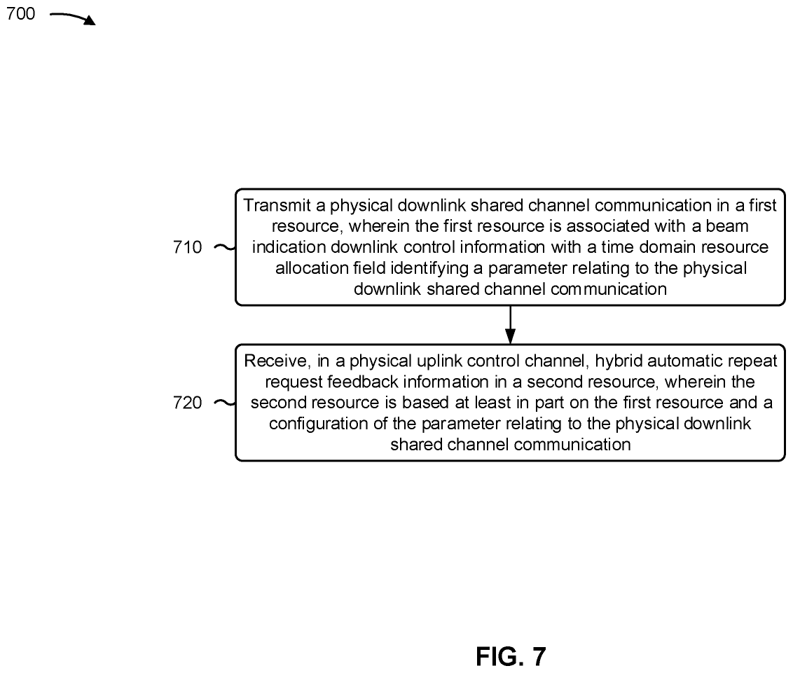

The controller/processor 240 of the base station 110, the controller/processor 280 of the UE 120, and/or any other component(s) of FIG. 2 may perform one or more techniques associated with transmission configuration indicator (TCI) indication in downlink control information (DCI) scheduling a virtual physical downlink shared channel (PDSCH), as described in more detail elsewhere herein. For example, the controller/processor 240 of the base station 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE 120 includes means for receiving a physical downlink shared channel communication in a first resource, wherein the first resource is associated with a beam indication downlink control information with a time domain resource allocation field identifying a parameter relating to the physical downlink shared channel communication: and/or means for transmitting, in a physical uplink control channel, hybrid automatic repeat request feedback information in a second resource, wherein the second resource is based at least in part on the first resource and a configuration of the parameter relating to the physical downlink shared channel communication. The means for the UE 120 to perform operations described herein may include, for example, one or more of communication manager 140, antenna 252, modem 254. MIMO detector 256, receive processor 258, transmit processor 264, TX MIMO processor 266, controller/processor 280, or memory 282.

In some aspects, a base station 110 includes means for transmitting a physical downlink shared channel communication in a first resource, wherein the first resource is associated with a beam indication downlink control information with a time domain resource allocation field identifying a parameter relating to the physical downlink shared channel communication: and/or means for receiving, in a physical uplink control channel, hybrid automatic repeat request feedback information in a second resource, wherein the second resource is based at least in part on the first resource and a configuration of the parameter relating to the physical downlink shared channel communication. The means for the base station 110 to perform operations described herein may include, for example, one or more of communication manager 150, transmit processor 220. TX MIMO processor 230, modem 232, antenna 234. MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

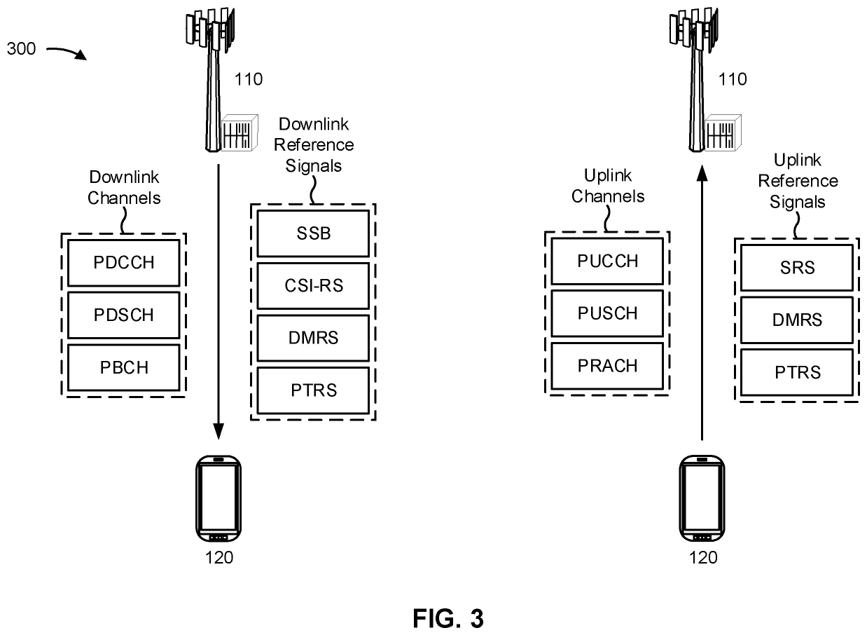

FIG. 3 is a diagram illustrating an example 300 of physical channels and reference signals in a wireless network, in accordance with the present disclosure. As shown in FIG. 3, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. PDSCH communications may be scheduled by PDCCH communications. For example, DCI may include parameters to schedule PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit hybrid automatic repeat request (HARQ) acknowledgement (ACK) or negative acknowledgement (NACK) feedback (e.g., ACK/NACK feedback or ACK/NACK information) in UCI on the PUCCH and/or the PUSCH. For transmission configuration indicator (TCI) indication without downlink assignment (e.g., with an assignment of downlink resources), a HARQ ACK may be reported in a PUCCH resource that occurs a quantity k slots after an end of a PDCCH communication. The parameter k may be indicated by a timing indicator field (e.g., a PDSCH-to-HARQ_feedback timing indicator field) in the DCI that conveys the TCI indication.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown. DMRSs are used for both downlink communications and uplink communications.

A PTRS may carry information used to compensate for oscillator phase noise. Typically, the phase noise increases as the oscillator carrier frequency increases. Thus. PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 3 is provided as an example. Other examples may differ from what is described with regard to FIG. 3.

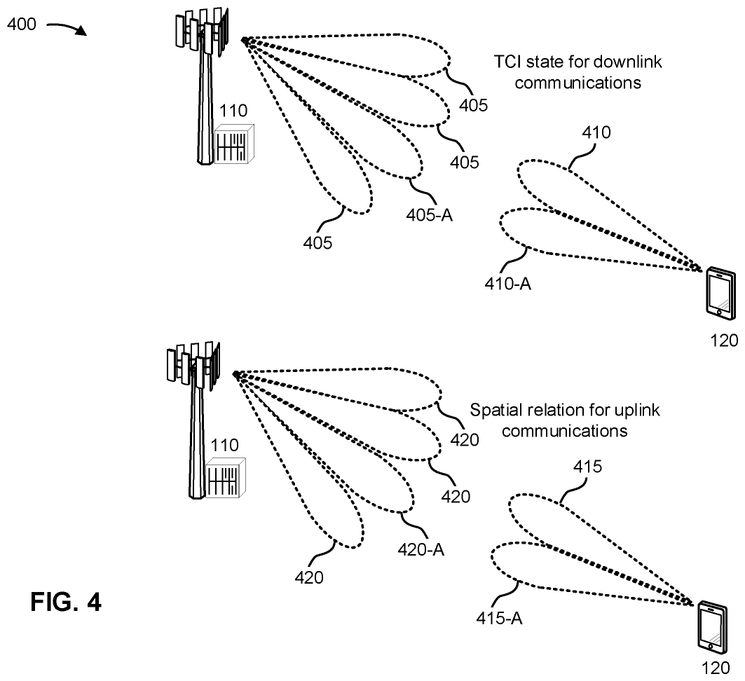

FIG. 4 is a diagram illustrating an example 400 of using beams for communications between a base station and a UE, in accordance with the present disclosure. As shown in FIG. 4, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 405.

The UE 120 may attempt to receive downlink transmissions via one or more UE receive beams 410, which may be configured using different beamforming parameters at receive circuitry of the UE 120. The UE 120 may identify a particular BS transmit beam 405, shown as BS transmit beam 405-A, and a particular UE receive beam 410, shown as UE receive beam 410-A, that provide relatively favorable performance (for example, that have a best channel quality of the different measured combinations of BS transmit beams 405 and UE receive beams 410). In some examples, the UE 120 may transmit an indication of which BS transmit beam 405 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 405-A and the UE receive beam 410-A), which may be further refined and maintained in accordance with one or more established beam refinement procedures.

A downlink beam, such as a BS transmit beam 405 or a UE receive beam 410, may be associated with a transmission configuration indication (TCI) state. A TCI state may indicate a directionality or a characteristic of the downlink beam, such as one or more QCL properties of the downlink beam. A QCL property may include, for example, a Doppler shift, a Doppler spread, an average delay, a delay spread, or spatial receive parameters, among other examples. In some examples, each BS transmit beam 405 may be associated with a synchronization signal block (SSB), and the UE 120 may indicate a preferred BS transmit beam 405 by transmitting uplink transmissions in resources of the SSB that are associated with the preferred BS transmit beam 405. A particular SSB may have an associated TCI state (for example, for an antenna port or for beamforming). The base station 110 may, in some examples, indicate a downlink BS transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift. Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the base station 110 indicating a BS transmit beam 405 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 415.

The base station 110 may receive uplink transmissions via one or more BS receive beams 420. The base station 110 may identify a particular UE transmit beam 415, shown as UE transmit beam 415-A, and a particular BS receive beam 420, shown as BS receive beam 420-A, that provide relatively favorable performance (for example, that have a best channel quality of the different measured combinations of UE transmit beams 415 and BS receive beams 420). In some examples, the base station 110 may transmit an indication of which UE transmit beam 415 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 415-A and the BS receive beam 420-A), which may be further refined and maintained in accordance with one or more established beam refinement procedures. An uplink beam, such as a UE transmit beam 415 or a BS receive beam 420, may be associated with a spatial relation. A spatial relation may indicate a directionality or a characteristic of the uplink beam, similar to one or more QCL properties, as described above.

Different types of TCI states and associated spatial relations may be possible. 3GPP has discussed adding a new group of TCI states, which may be termed “Unified TCI Types” for 3GPP Release 17. In the unified TCI types, type 1 TCI is a joint downlink and uplink (DL/UL) common TCI state to indicate a common beam for at least one downlink channel or reference signal and at least one uplink channel or reference signal. In the unified TCI types, type 2 TCI is a separate common TCI state to indicate a common beam for at least two downlink channels or reference signals. In the unified TCI types, type 3 TCI is a separate uplink common TCI state to indicate a common beam for at least two uplink channels or reference signals. In the unified TCI types, type 4 TCI is a separate downlink single channel or single reference signal TCI state to indicate a beam for a single downlink channel or reference signal. In the unified TCI types, type 5 TCI is a separate uplink single channel or single reference signal TCI state to indicate a beam for a single uplink channel or reference signal. In the unified TCI types, type 6 TCI is an uplink spatial relationship information (SRI) to indicate a beam for a single uplink channel or reference signal.

As indicated above. FIG. 4 is provided as an example. Other examples may differ from what is described with respect to FIG. 4.

In some communications systems, a base station may transmit DCI to update a TCI state, such as a unified TCI type state, as described above. For example, DCI format 1_1 or 1_2, which are DCI formats that include or not include a downlink assignment of data, can be used to indicate a TCI state. When DCI does not include a downlink assignment of data, some fields of such DCI may be set for other purposes. When a UE receives DCI, in a PDCCH, with a parameter updating a TCI state, which may be termed a “beam indication DCI” the UE may transmit a HARQ ACK message. For example, upon successful reception of a beam indication DCI, the UE may report an ACK to the base station (and upon a failed reception of the beam indication DCI, the UE may report a NACK to the base station).

For a type-1 HARQ-ACK codebook, a resource location for transmitting an ACK in the HARQ-ACK codebook is based at least in part on a virtual PDSCH (e.g., a PDSCH associated with a DCI, but which is not actually transmitted by the base station) indicated by a time domain resource allocation (TDRA) field of the beam indication DCI and/or a time domain allocation list configured for PDSCH communication. Similarly, for type-2 HARQ-ACK codebook, a resource location for transmitting an ACK is based at least in part on a procedure that is defined for semi-persistent scheduling (SPS) release. In these cases, the UE may report the ACK in a PUCCH communication occurring k slots after an end of a reception of a PDCCH that includes the DCI. The parameter k may be based at least in part on a timing indicator (e.g., a PDSCH-to-HARQ_feedback timing indicator field) of the DCI. Alternatively, the parameter k may be based on a timing indicator not included in the DCI, such as a timing indicator of a dl-DataToUL-ACK or a dl-DataToUL-ACK-ForDCI-Format1-2-r16 parameter. A UE may also report HARQ ACK feedback as a response to receiving a PDSCH or SPS PDSCH release. The UE may report the HARQ ACK feedback in a HARQ-ACK codebook that the UE transmits in a slot indicated by a value of a PDSCH-to-HARQ feedback timing indicator filed in DCI corresponding to the PDSCH reception or SPS PDSCH release.

It has been proposed that a base station be enabled to transmit DCI, in a PDCCH, with a TCI indication and without a downlink assignment (or with a virtual PDSCH scheduling). In this case, the UE may be configured to report HARQ feedback (e.g., an ACK) in a PUCCH resource occurring k slots after an end of a PDCCH reception. A first parameter k0 may represent a time (e.g., a quantity of slots) between the PDCCH reception and a virtual PDSCH reception and a second parameter k1 may represent a time (e.g., a number of slots) between the virtual PDSCH (scheduled) reception and a HARQ transmission occasion. In legacy PDSCH scheduling (e.g., without a virtual PDSCH configured). PDSCH scheduling is causal, which results in k=k0+k1 where both k0 and k1 are greater than or equal to 0). Accordingly, the HARQ transmission occasion occurs after both the PDCCH and the PDSCH, thereby enabling the UE to transmit HARQ feedback in the HARQ occasion. However, with virtual PDSCH scheduling, if k0>0 and k0<k1, the virtual PDSCH occasion may occur after the HARQ transmission occasion.

Some aspects described herein provide for TCI indication in DCI scheduling a virtual PDSCH. For example, in some aspects described herein, a base station may set a value of k0=0) in a TDRA field of DCI such that k=k0+k1=k1. As another example, in some aspects described herein, the UE may receive a DCI with a TDRA field set to a value of k0>0, but the UE may override the k0 value and treat k0=0 for the indicated TDRA field in DCI. Alternatively, the base station may indicate a value of k based at least in part on a resource location of a slot that contains a virtual PDSCH occurring after an end of a PDCCH. Alternatively, the base station may indicate a virtual PDSCH occasion to a resource location within a candidate k1 window or within an occasion list associated with a HARQ codebook. In this case, when a UE receives DCI with a TCI indication and without an assignment of resources for data transmission, the UE may determine the HARQ codebook for transmitting an ACK to the TCI indication and transmit a response to the DCI with the TCI indication in the HARQ codebook. In this way, the UE may identify a resource location in which to transmit a feedback message as a response to receiving a beam indication DCI that does not include an assignment of resources for downlink communication, thereby increasing network flexibility, reducing network congestion from requiring that an assignment of resources be included in DCI, and/or avoiding dropped messages from ambiguities in the resource location for transmitting the feedback message, among other examples.

FIGS. 5A and 5B are diagrams illustrating an example 500 associated with TCI indication in DCI scheduling a virtual PDSCH, in accordance with the present disclosure. As shown in FIG. 5A, example 500 includes communication between a base station 110 and a UE 120. In some aspects, base station 110 and UE 120 may be included in a wireless network, such as wireless network 100. Base station 110 and UE 120 may communicate via a wireless access link, which may include an uplink and a downlink.

As further shown in FIG. 5A, and by reference number 510. UE 120 may receive a PDCCH in a first resource. For example, UE 120 may receive a beam indication DCI (e.g., a DCI identifying a TCI state). In some aspects, the beam indication DCI may be associated with a particular format, such as DCI format 1_1 or DCI format 1_2. For example, UE 120 may receive a DCI with one or more values in one or more fields to indicate the DCI does not include a downlink assignment for a PDSCH. In this case, the DCI may include an indicator of a virtual PDSCH. In some aspects. UE 120 may determine a parameter k, which may indicate when UE 120 is to transmit feedback information to acknowledge receipt of the PDCCH and the DCI. For example, UE 120 may decode the PDCCH and identify a timing indicator field (e.g., a PDSCH-to-HARQ_feedback timing indicator field), which identifies a value for k. Additionally. or alternatively. UE 120 may receive an indication of the parameter k separate from the beam indication DCI. For example, UE 120 may receive RRC signaling, such as a dl-DataToUL-ACK or dl-DataToUL-ACK-ForDCI-Format1-2-r16 field of a signaling message.

As further shown in FIG. 5A, and by reference number 520. UE 120 may determine a second resource in which to transmit a feedback message, such as a HARQ ACK. For example, UE 120 may determine that a virtual PDSCH indicated by the DCI has a value of k0=0 based at least in part on a TDRA field value of the beam indication DCI. UE 120 may be configured to receive, from the base station 110, a beam indication DCI without assignment of PDSCH and with k0=0 in the TDRA field of DCI. Alternatively. UE 120 may receive a beam indication DCI without an assignment of a PDSCH and treat k0=0 in the TDRA field of DCI (even when another value of k0 is indicated in the DCI). In this case, as shown in FIG. 5B, and by reference number 522. UE 120 may determine that k=k0+k1=k1, and may determine to transmit a HARQ ACK at a time k1 after the PDCCH with beam indication (e.g., since the virtual PDSCH is in the same slot as the PDCCH).

In some aspects. UE 120 may determine the second resource based at least in part on a resource for which the virtual PDSCH is scheduled. For example, UE 120 may determine that k is to start from a slot that contains the virtual PDSCH occurring after the end of the PDCCH reception. In this case, the virtual PDSCH may occur between slots n−N+1 and slot n, where Vis based at least in part on an aggregation factor (e.g., a pdsch-AggreationFactor or a pdsch-AggregationFactor-r16 field, as described in more detail herein with regard to 3GPP Technical Specification (TS) 38.214 release 16 version 16.6.0). Additionally, or alternatively, when the TDRA field in the beam indication DCI indicates that an entry includes a repetition number q, the virtual PDSCH may occur between slot n−q+1 and slot n, where q represents the repetition number (e.g., a repetition Number field). Additionally, or alternatively, the virtual PDSCH may be constrained to occurring in slot n. In this case, as shown in FIG. 5B, and by reference number 524, k0=0, but k is initialized from the end of PDSCH and k=k1.

In some aspects. UE 120 may determine the second resource based at least in part on a window for the PDSCH occasion. For example, the beam indication DCI may indicate a virtual PDSCH occasion in a candidate k1 window or in an occasion list that is to be reported in connection with the HARQ codebook. In this case, when the beam indication DCI includes a TDRA field that indicates a value of k0 for a virtual PDSCH and the beam indication DCI indicates a value for k1 for HARQ-ACK timing, the base station 110 may indicate a value of k1 greater than or equal to k0, such that a time offset k1′ which is equal to k1-k0 may fall in the set of slot timing values k1 for the UE 120 to determine the PDSCH candidate occasions for a HARQ codebook. Alternatively, the virtual PDSCH indicated by the beam indication DCI may be in a time window after a PDCCH with a beam indication DCI and before a HARQ codebook occasion, and may be in a time window associated with a set of slot timings indexed by values of k1 configured in the time domain resource allocation list for the TDRA field of DCI (e.g., which are used for the UE 120 to determine a HARQ codebook). UE 120 may determine a time offset k1′=k1−k0 from a set of slot timing values k1. In this case, as shown in FIG. 5B, and by reference number 526. UE 120 may determine the second resource location within a HARQ codebook based at least in part on a slot offset value for feedback of the acknowledgement information (e.g., an ACK or NACK) as a response to the beam indication DCI.

The second resource location within a HARQ codebook may be based at least in part on a PDSCH reception occasion indexed by a slot offset value of (k0, k1). For example, in a first option. UE 120 may determine the second resource within a HARQ codebook based at least in part on parameters k0 and k1 (e.g., based at least in part on a virtual PDSCH occasion identified by a slot offset value of (k0, k1)) where k0 is the time offset between the beam indication DCI and the PDSCH reception occasion for determining the second resource location within a HARQ codebook and k1 is the time offset between the PDSCH reception occasion for determining the second resource location within a HARQ codebook and the HARQ transmission occasion. In a second option. UE 120 may determine the second resource within a HARQ codebook based at least in part on parameters k0 and k1′ (e.g., based at least in part on a virtual PDSCH occasion identified by a slot offset value of (k0, k1′=k1-k0)) where k0 is the time offset between the beam indication DCI and the PDSCH reception occasion for determining the second resource location within a HARQ codebook and k1′ is the time offset between the PDSCH reception occasion for determining the second resource location within a HARQ codebook and the HARQ transmission occasion. In a third option. UE 120 may determine the second resource within a HARQ codebook based at least in part on parameters k0′ and k1 (e.g., based at least in part on a virtual PDSCH occasion identified by a slot offset value of (k0′=k1-k0, k1)), where k0′ is the time offset between the beam indication DCI and the PDSCH reception occasion for determining the second resource location within a HARQ codebook and k1 is the time offset between the PDSCH reception occasion for determining the second resource location within a HARQ codebook and the HARQ transmission occasion.

As a result. UE 120 may determine a set of occasions for candidate PDSCH receptions and UE 120 may determine to transmit corresponding HARQ-ACK information in a PUCH in a slot n that is based at least in part on the set of occasions for the candidate PDSCH receptions. Additional details regarding the timing are described with regard to 3GPP TS 38.213, release 16, version 16.6.0. Section 9.1.2.1. In some aspects, for type-1 HARQ-ACK codebooks. UE 120 may determine a location for transmitting an ACK based at least in part on a virtual PDSCH indicated by a TDRA field in the beam indication DCI, a time domain allocation list configured for PDSCH communication, a timing indicator filed (e.g., PDSCH-to-HARQ_feedback, dl-DataToUL-ACK, or dl-DataToUL-ACK-ForDCI-Format1-2-r16).

As further shown in FIG. 5A, and by reference number 530. UE 120 may transmit feedback information in a second resource. For example, based at least in part on determining the second resource. UE 120 may transmit a HARQ ACK in a PUCCH associated with the second resource.

As indicated above. FIGS. 5A and 5B are provided as examples. Other examples may differ from what is described with respect to FIGS. 5A and 5B.

FIG. 6 is a diagram illustrating an example process 600 performed, for example, by a user equipment (UE), in accordance with the present disclosure. Example process 600 is an example where the UE (e.g., UE 120) performs operations associated with TCI indication in DCI scheduling a virtual PDSCH.

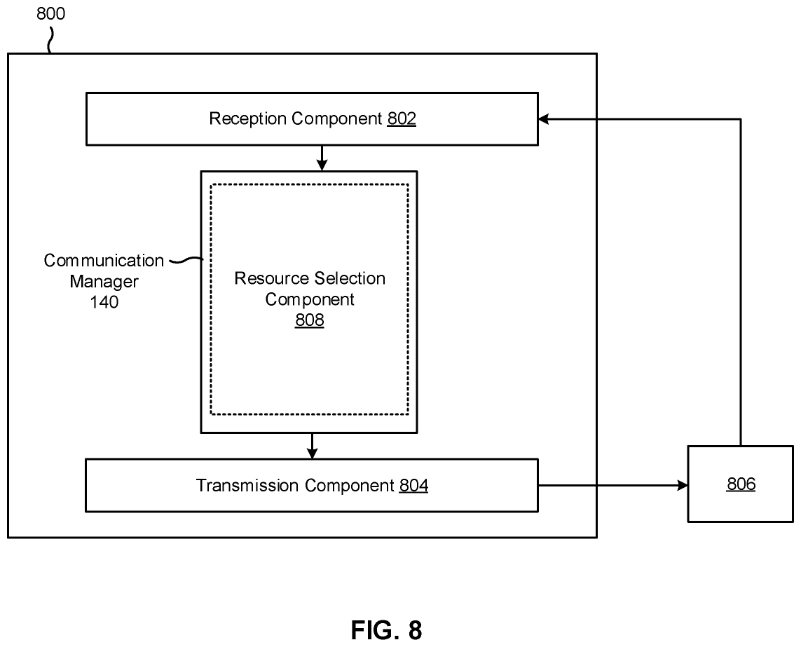

As shown in FIG. 6, in some aspects, process 600 may include receiving a physical downlink shared channel communication in a first resource, wherein the first resource is associated with a beam indication downlink control information with a time domain resource allocation field identifying a parameter relating to the physical downlink shared channel communication (block 610). For example, the UE (e.g., using communication manager 140 and/or reception component 802, depicted in FIG. 8) may receive a physical downlink shared channel communication in a first resource, wherein the first resource is associated with a beam indication downlink control information with a time domain resource allocation field identifying a parameter relating to the physical downlink shared channel communication, as described above.

As further shown in FIG. 6, in some aspects, process 600 may include transmitting, in a physical uplink control channel, hybrid automatic repeat request feedback information in a second resource, wherein the second resource is based at least in part on the first resource and a configuration of the parameter relating to the physical downlink shared channel communication (block 620). For example, the UE (e.g., using communication manager 140 and/or transmission component 804, depicted in FIG. 8) may transmit, in a physical uplink control channel, hybrid automatic repeat request feedback information in a second resource, wherein the second resource is based at least in part on the first resource and a configuration of the parameter relating to the physical downlink shared channel communication, as described above.

Process 600 may include additional aspects, such as any single aspect or any combination of aspects described below and/or in connection with one or more other processes described elsewhere herein.

In a first aspect, the physical downlink shared channel communication is associated with a transmission configuration indicator state identifying a downlink configuration and an uplink configuration.

In a second aspect, alone or in combination with the first aspect, the downlink control information is associated with format 1_1 or 1_2 without a downlink assignment.

In a third aspect, alone or in combination with one or more of the first and second aspects, the second resource is based at least in part on an end of a reception of the physical downlink shared channel communication in the first resource.

In a fourth aspect, alone or in combination with one or more of the first through third aspects, the second resource is based at least in part on a timing indicator field associated with the downlink control information.

In a fifth aspect, alone or in combination with one or more of the first through fourth aspects, the second resource is based at least in part on a parameter identifying a timing associated with downlink data reception and uplink acknowledgement transmission.

In a sixth aspect, alone or in combination with one or more of the first through fifth aspects, the parameter is associated with a value set to 0 in the time domain resource allocation field of the downlink control information.

In a seventh aspect, alone or in combination with one or more of the first through sixth aspects, the parameter is associated with a value based at least in part on an aggregation factor for the physical downlink shared channel communication.

In an eighth aspect, alone or in combination with one or more of the first through seventh aspects, the parameter is associated with a value based at least in part on a repetition number associated with the time domain resource allocation field of the downlink control information.

In a ninth aspect, alone or in combination with one or more of the first through eighth aspects, the parameter is associated with a value based at least in part on a slot that includes the physical downlink shared channel.

In a tenth aspect, alone or in combination with one or more of the first through ninth aspects, the parameter is associated with a value based at least in part on a set of occasions for candidate physical downlink shared channel receptions.

In an eleventh aspect, alone or in combination with one or more of the first through tenth aspects, the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

In a twelfth aspect, alone or in combination with one or more of the first through eleventh aspects, the parameter is associated with a value based at least in part on a slot offset value.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a base station, in accordance with the present disclosure. Example process 700 is an example where the base station (e.g., base station 110) performs operations associated with TCI indication in DCI scheduling a virtual PDSCH.

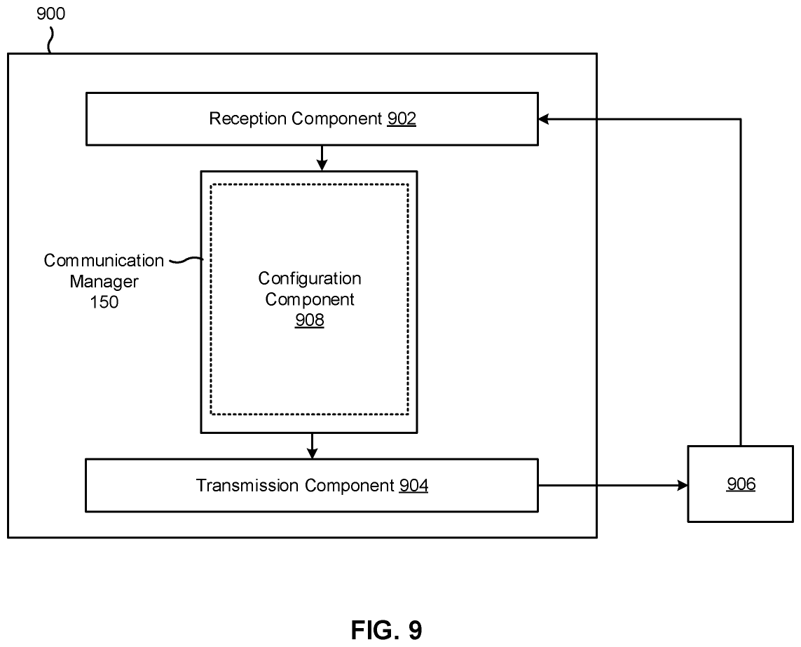

As shown in FIG. 7, in some aspects, process 700 may include transmitting a physical downlink shared channel communication in a first resource, wherein the first resource is associated with a beam indication downlink control information with a time domain resource allocation field identifying a parameter relating to the physical downlink shared channel communication (block 710). For example, the base station (e.g., using communication manager 150 and/or transmission component 904, depicted in FIG. 9) may transmit a physical downlink shared channel communication in a first resource, wherein the first resource is associated with a beam indication downlink control information with a time domain resource allocation field identifying a parameter relating to the physical downlink shared channel communication, as described above.

As further shown in FIG. 7, in some aspects, process 700 may include receiving, in a physical uplink control channel, hybrid automatic repeat request feedback information in a second resource, wherein the second resource is based at least in part on the first resource and a configuration of the parameter relating to the physical downlink shared channel communication (block 720). For example, the base station (e.g., using communication manager 150 and/or reception component 902, depicted in FIG. 9) may receive, in a physical uplink control channel, hybrid automatic repeat request feedback information in a second resource, wherein the second resource is based at least in part on the first resource and a configuration of the parameter relating to the physical downlink shared channel communication, as described above.

Process 700 may include additional aspects, such as any single aspect or any combination of aspects described below and/or in connection with one or more other processes described elsewhere herein.

In a first aspect, the physical downlink shared channel communication is associated with a transmission configuration indicator state identifying a downlink configuration and an uplink configuration.

In a second aspect, alone or in combination with the first aspect, the downlink control information is associated with format 1_1 or 1_2 without a downlink assignment.

In a third aspect, alone or in combination with one or more of the first and second aspects, the second resource is based at least in part on an end of a reception of the physical downlink shared channel communication in the first resource.

In a fourth aspect, alone or in combination with one or more of the first through third aspects, the second resource is based at least in part on a timing indicator field associated with the downlink control information.

In a fifth aspect, alone or in combination with one or more of the first through fourth aspects, the second resource is based at least in part on a parameter identifying a timing associated with downlink data reception and uplink acknowledgement transmission.

In a sixth aspect, alone or in combination with one or more of the first through fifth aspects, the parameter is associated with a value set to 0 in the time domain resource allocation field of the downlink control information.

In a seventh aspect, alone or in combination with one or more of the first through sixth aspects, the parameter is associated with a value based at least in part on an aggregation factor for the physical downlink shared channel communication.

In an eighth aspect, alone or in combination with one or more of the first through seventh aspects, the parameter is associated with a value based at least in part on a repetition number associated with the time domain resource allocation field of the downlink control information.

In a ninth aspect, alone or in combination with one or more of the first through eighth aspects, the parameter is associated with a value based at least in part on a slot that includes the physical downlink shared channel.

In a tenth aspect, alone or in combination with one or more of the first through ninth aspects, the parameter is associated with a value based at least in part on a set of occasions for candidate physical downlink shared channel receptions.

In an eleventh aspect, alone or in combination with one or more of the first through tenth aspects, the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

In a twelfth aspect, alone or in combination with one or more of the first through eleventh aspects, the parameter is associated with a value based at least in part on a slot offset value.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a resource selection component 808 among other examples.

In some aspects, the apparatus 800 may be configured to perform one or more operations described herein in connection with FIGS. 5A and 5B. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 806. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 806 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive a physical downlink shared channel communication in a first resource, wherein the first resource is associated with a beam indication downlink control information with a time domain resource allocation field identifying a parameter relating to the physical downlink shared channel communication. The transmission component 804 may transmit, in a physical uplink control channel, hybrid automatic repeat request feedback information in a second resource, wherein the second resource is based at least in part on the first resource and a configuration of the parameter relating to the physical downlink shared channel communication. The resource selection component 808 may select the second resource for transmission of the physical uplink control channel.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a base station, or a base station may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 150. The communication manager 150 may include one or more of a configuration component 908, among other examples.

In some aspects, the apparatus 900 may be configured to perform one or more operations described herein in connection with FIGS. 5A and 5B. Additionally, or alternatively, the apparatus 900 may be configured to perform one or more processes described herein, such as process 700 of FIG. 7. In some aspects, the apparatus 900 and/or one or more components shown in FIG. 9 may include one or more components of the base station described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a modem, a demodulator, a MIMO detector, a receive processor, a controller/processor, a memory, or a combination thereof, of the base station described in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the base station described in connection with FIG. 2. In some aspects, the transmission component 904 may be co-located with the reception component 902 in a transceiver.

The transmission component 904 may transmit a physical downlink shared channel communication in a first resource, wherein the first resource is associated with a beam indication downlink control information with a time domain resource allocation field identifying a parameter relating to the physical downlink shared channel communication. The reception component 902 may receive, in a physical uplink control channel, hybrid automatic repeat request feedback information in a second resource, wherein the second resource is based at least in part on the first resource and a configuration of the parameter relating to the physical downlink shared channel communication. The configuration component 908 may configure resource selection by the apparatus 906 (e.g., a UE 120).

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a user equipment (UE), comprising: receiving a physical downlink shared channel communication in a first resource, wherein the first resource is associated with a beam indication downlink control information with a time domain resource allocation field identifying a parameter relating to the physical downlink shared channel communication: and transmitting, in a physical uplink control channel, hybrid automatic repeat request feedback information in a second resource, wherein the second resource is based at least in part on the first resource and a configuration of the parameter relating to the physical downlink shared channel communication.

Aspect 2: The method of Aspect 1, wherein the physical downlink shared channel communication is associated with a transmission configuration indicator state identifying a downlink configuration and an uplink configuration.

Aspect 3: The method of any of Aspects 1 to 2, wherein the downlink control information is associated with format 1_1 or 1_2 without a downlink assignment.

Aspect 4: The method of any of Aspects 1 to 3, wherein the second resource is based at least in part on an end of a reception of the physical downlink shared channel communication in the first resource.

Aspect 5: The method of any of Aspects 1 to 4, wherein the second resource is based at least in part on a timing indicator field associated with the downlink control information.

Aspect 6: The method of any of Aspects 1 to 5, wherein the second resource is based at least in part on a parameter identifying a timing associated with downlink data reception and uplink acknowledgement transmission.

Aspect 7: The method of any of Aspects 1 to 6, wherein the parameter is associated with a value set to 0 in the time domain resource allocation field of the downlink control information.

Aspect 8: The method of any of Aspects 1 to 7, wherein the parameter is associated with a value based at least in part on an aggregation factor for the physical downlink shared channel communication.

Aspect 9: The method of any of Aspects 1 to 8, wherein the parameter is associated with a value based at least in part on a repetition number associated with the time domain resource allocation field of the downlink control information.

Aspect 10: The method of any of Aspects 1 to 9, wherein the parameter is associated with a value based at least in part on a slot that includes the physical downlink shared channel.

Aspect 11: The method of any of Aspects 1 to 10, wherein the parameter is associated with a value based at least in part on a set of occasions for candidate physical downlink shared channel receptions.

Aspect 12: The method of any of Aspects 1 to 11, wherein the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

Aspect 13: The method of any of Aspects 1 to 12, wherein the parameter is associated with a value based at least in part on a slot offset value.

Aspect 14: A method of wireless communication performed by a base station, comprising: transmitting a physical downlink shared channel communication in a first resource, wherein the first resource is associated with a beam indication downlink control information with a time domain resource allocation field identifying a parameter relating to the physical downlink shared channel communication; and receiving, in a physical uplink control channel, hybrid automatic repeat request feedback information in a second resource, wherein the second resource is based at least in part on the first resource and a configuration of the parameter relating to the physical downlink shared channel communication.

Aspect 15: The method of Aspect 14, wherein the physical downlink shared channel communication is associated with a transmission configuration indicator state identifying a downlink configuration and an uplink configuration.

Aspect 16: The method of any of Aspects 14 to 15, wherein the downlink control information is associated with format 1_1 or 1_2 without a downlink assignment.

Aspect 17: The method of any of Aspects 14 to 16, wherein the second resource is based at least in part on an end of a reception of the physical downlink shared channel communication in the first resource.

Aspect 18: The method of any of Aspects 14 to 17, wherein the second resource is based at least in part on a timing indicator field associated with the downlink control information.

Aspect 19: The method of any of Aspects 14 to 18, wherein the second resource is based at least in part on a parameter identifying a timing associated with downlink data reception and uplink acknowledgement transmission.

Aspect 20: The method of any of Aspects 14 to 19, wherein the parameter is associated with a value set to 0 in the time domain resource allocation field of the downlink control information.

Aspect 21: The method of any of Aspects 14 to 20, wherein the parameter is associated with a value based at least in part on an aggregation factor for the physical downlink shared channel communication.

Aspect 22: The method of any of Aspects 14 to 21, wherein the parameter is associated with a value based at least in part on a repetition number associated with the time domain resource allocation field of the downlink control information.

Aspect 23: The method of any of Aspects 14 to 22, wherein the parameter is associated with a value based at least in part on a slot that includes the physical downlink shared channel.

Aspect 24: The method of any of Aspects 14 to 23, wherein the parameter is associated with a value based at least in part on a set of occasions for candidate physical downlink shared channel receptions.

Aspect 25: The method of any of Aspects 14 to 24, wherein the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

Aspect 26: The method of any of Aspects 14 to 25, wherein the parameter is associated with a value based at least in part on a slot offset value.

Aspect 27: An apparatus for wireless communication at a device, comprising a processor: memory coupled with the processor; and instructions stored in the memory and executable by the processor to cause the apparatus to perform the method of one or more of Aspects 1-13.

Aspect 28: A device for wireless communication, comprising a memory and one or more processors coupled to the memory, the one or more processors configured to perform the method of one or more of Aspects 1-13.

Aspect 29: An apparatus for wireless communication, comprising at least one means for performing the method of one or more of Aspects 1-13.

Aspect 30: A non-transitory computer-readable medium storing code for wireless communication, the code comprising instructions executable by a processor to perform the method of one or more of Aspects 1-13.

Aspect 31: A non-transitory computer-readable medium storing a set of instructions for wireless communication, the set of instructions comprising one or more instructions that, when executed by one or more processors of a device, cause the device to perform the method of one or more of Aspects 1-13.

Aspect 32: An apparatus for wireless communication at a device, comprising a processor: memory coupled with the processor: and instructions stored in the memory and executable by the processor to cause the apparatus to perform the method of one or more of Aspects 14-26.

Aspect 33: A device for wireless communication, comprising a memory and one or more processors coupled to the memory, the one or more processors configured to perform the method of one or more of Aspects 14-26.

Aspect 34: An apparatus for wireless communication, comprising at least one means for performing the method of one or more of Aspects 14-26.

Aspect 35: A non-transitory computer-readable medium storing code for wireless communication, the code comprising instructions executable by a processor to perform the method of one or more of Aspects 14-26.

Aspect 36: A non-transitory computer-readable medium storing a set of instructions for wireless communication, the set of instructions comprising one or more instructions that, when executed by one or more processors of a device, cause the device to perform the method of one or more of Aspects 14-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having.” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive a physical downlink shared channel communication in a first resource, wherein the first resource is associated with a beam indication downlink control information with a time domain resource allocation field identifying a parameter relating to the physical downlink shared channel communication; and
transmit, in a physical uplink control channel, hybrid automatic repeat request feedback information in a second resource, wherein the second resource is based at least in part on the first resource and a configuration of the parameter relating to the physical downlink shared channel communication.

2. The UE of claim 1, wherein the physical downlink shared channel communication is associated with a transmission configuration indicator state identifying a downlink configuration and an uplink configuration.

3. The UE of claim 1, wherein the downlink control information is associated with format 1_1 or 1_2 without a downlink assignment.

4. The UE of claim 1, wherein the second resource is based at least in part on an end of a reception of the physical downlink shared channel communication in the first resource.

5. The UE of claim 1, wherein the second resource is based at least in part on a timing indicator field associated with the downlink control information.

6. The UE of claim 1, wherein the second resource is based at least in part on a parameter identifying a timing associated with downlink data reception and uplink acknowledgement transmission.

7. The UE of claim 1, wherein the parameter is associated with a value set to 0 in the time domain resource allocation field of the downlink control information.

8. The UE of claim 1, wherein the parameter is associated with a value based at least in part on an aggregation factor for the physical downlink shared channel communication.

9. The UE of claim 1, wherein the parameter is associated with a value based at least in part on a repetition number associated with the time domain resource allocation field of the downlink control information.

10. The UE of claim 1, wherein the parameter is associated with a value based at least in part on a slot that includes the physical downlink shared channel.

11. The UE of claim 1, wherein the parameter is associated with a value based at least in part on a set of occasions for candidate physical downlink shared channel receptions.

12. The UE of claim 1, wherein the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

13. The UE of claim 1, wherein the parameter is associated with a value based at least in part on a slot offset value.

14. A base station for wireless communication, comprising:
a memory; and
one or more processors, coupled to the memory, configured to:
transmit a physical downlink shared channel communication in a first resource, wherein the first resource is associated with a beam indication downlink control information with a time domain resource allocation field identifying a parameter relating to the physical downlink shared channel communication; and
receive, in a physical uplink control channel, hybrid automatic repeat request feedback information in a second resource, wherein the second resource is based at least in part on the first resource and a configuration of the parameter relating to the physical downlink shared channel communication.

15. The base station of claim 14, wherein the physical downlink shared channel communication is associated with a transmission configuration indicator state identifying a downlink configuration and an uplink configuration.

16. The base station of claim 14, wherein the downlink control information is associated with format 1_1 or 1_2 without a downlink assignment.

17. The base station of claim 14, wherein the second resource is based at least in part on an end of a reception of the physical downlink shared channel communication in the first resource.

18. The base station of claim 14, wherein the second resource is based at least in part on a timing indicator field associated with the downlink control information.

19. The base station of claim 14, wherein the second resource is based at least in part on a parameter identifying a timing associated with downlink data reception and uplink acknowledgement transmission.

20. The base station of claim 14, wherein the parameter is associated with a value set to 0 in the time domain resource allocation field of the downlink control information.

21. The base station of claim 14, wherein the parameter is associated with a value based at least in part on an aggregation factor for the physical downlink shared channel communication.

22. The base station of claim 14, wherein the parameter is associated with a value based at least in part on a repetition number associated with the time domain resource allocation field of the downlink control information.

23. The base station of claim 14, wherein the parameter is associated with a value based at least in part on a slot that includes the physical downlink shared channel.

24. The base station of claim 14, wherein the parameter is associated with a value based at least in part on a set of occasions for candidate physical downlink shared channel receptions.

25. The base station of claim 14, wherein the parameter is associated with a value based at least in part on at least one of the time domain resource allocation field of the downlink control information, a time domain resource allocation list configured for the physical downlink shared channel, a timing indicator field of the downlink control information, or a downlink data to uplink acknowledgement parameter.

26. The base station of claim 14, wherein the parameter is associated with a value based at least in part on a slot offset value.

27. A method of wireless communication performed by a user equipment (UE), comprising:
receiving a physical downlink shared channel communication in a first resource, wherein the first resource is associated with a beam indication downlink control information with a time domain resource allocation field identifying a parameter relating to the physical downlink shared channel communication; and
transmitting, in a physical uplink control channel, hybrid automatic repeat request feedback information in a second resource, wherein the second resource is based at least in part on the first resource and a configuration of the parameter relating to the physical downlink shared channel communication.

28. The method of claim 27, wherein the physical downlink shared channel communication is associated with a transmission configuration indicator state identifying a downlink configuration and an uplink configuration.

29. A method of wireless communication performed by a base station, comprising:
transmitting a physical downlink shared channel communication in a first resource, wherein the first resource is associated with a beam indication downlink control information with a time domain resource allocation field identifying a parameter relating to the physical downlink shared channel communication; and
receiving, in a physical uplink control channel, hybrid automatic repeat request feedback information in a second resource, wherein the second resource is based at least in part on the first resource and a configuration of the parameter relating to the physical downlink shared channel communication.

30. The method of claim 29, wherein the physical downlink shared channel communication is associated with a transmission configuration indicator state identifying a downlink configuration and an uplink configuration.

31.-34. (canceled)
